(19) United States
(12) Patent Application Publication
(10) Pub. No.: US 2026/0238614 A1
(43) Pub. Date: Aug. 13, 2026

(54) OPTIMIZED DEEP PACKET INSPECTION FOR ROLE-BASED POLICIES

(71) Applicant: HEWLETT PACKARD ENTERPRISE DEVELOPMENT LP, Spring, TX (US)

(72) Inventors: Venkata Varadhan Devarajan, Bangalore (IN); Balaji Sankaran, Bangalore (IN); Vijeesh Erankotte Panayamthatta, Bangalore (IN)

(21) Appl. No.: 19/190,679

(22) Filed: Apr. 27, 2025

(30) Foreign Application Priority Data
Feb. 7, 2025 (IN) 202541010849

(51) Int. Cl. H04L 9/40; H04L 43/028

(52) U.S. Cl. CPC H04L 63/0236; H04L 43/028; H04L 63/105

(57) ABSTRACT

Techniques are provided herein for selective deep packet inspection. Deep packet inspection (DPI) is implemented selectively for particular data packets that are associated with one or more policies that include a DPI component, such as a DPI-identified criteria and/or a DPI-dependent action.

### BACKGROUND

The present disclosure relates generally to optimized deep packet inspection (DPI). More specifically, the present disclosure relates to optimizing DPI for role-based policies.

Deep packet inspection (DPI) analyzes network traffic, such as data packets, as it flows through a network to identify characteristics of the network traffic. For example, such characteristics may include a particular application, particular ports, certificate and/or secure hash algorithm (SHA) exchanges, universal resource locators (URLs) and/or Server Name Identification (SNI) accesses, and/or a particular version of Transport Layer Security (TLS) and/or Secure Sockets Layer (SSL) associated with the network traffic. The characteristics of the network traffic that are gleaned from the DPI may be used, for example in intrusion detection systems (IDS) and/or intrusion prevention systems (IPS) to detect and/or prevent malicious intrusion within a computer network. To do this, a signature of the network traffic may be identified based upon the characteristics and compared with known malicious network traffic patterns.

### DRAWINGS

These and other features, aspects, and advantages of the present disclosure will become better understood when the following detailed description is read with reference to the accompanying drawings in which like characters represent like parts throughout the drawings, wherein:

FIG. 1 is schematic diagram, illustrating a system that implements efficient selective deep packet inspection (DPI), in accordance with aspects of the present disclosure;

FIG. 2 is a flowchart, illustrating a process for selective DPI, in accordance with aspects of the present disclosure;

FIG. 3 is a schematic diagram, illustrating an example network infrastructure that implements selective DPI, in accordance with aspects of the present disclosure;

FIG. 4 is a schematic diagram, illustrating a data flow path and DPI processor coordination to implement the selective DPI of FIG. 3, in accordance with aspects of the present disclosure;

FIG. 5 is a flowchart, illustrating a process for implementing role-to-role policies with DPI, in accordance with aspects of the present disclosure;

FIG. 6 is a schematic diagram, illustrating an example network infrastructure that implements a role-to-role policy with DPI, in accordance with aspects of the present disclosure; and

FIG. 7 is a schematic diagram, illustrating data flow path and DPI processor coordination to implement the role-to-role policy with DPI of FIG. 6, in accordance with aspects of the present disclosure.

### DETAILED DESCRIPTION

Deep packet inspection (DPI) is a process that inspects data provided over a network to glean additional information from the data. In many cases, DPI is triggered on data packets flowing through a network component, regardless of whether DPI is actually needed for the data packets. DPI may be quite resource intensive and performing DPI that is not used may waste computing resources that could be used for other tasks. Accordingly, selective DPI may be used to reduce DPI to a set of data packets where DPI may be useful. This may result in significant computing resource efficiencies, freeing up computing resources for other tasks.

The present disclosure relates generally to such an implementation of selective DPI. More specifically, the present disclosure relates to a selective DPI implementation that selectively provides network traffic (e.g., a copy of received data packets) to a DPI processor for DPI based upon whether there are policies applicable to the network traffic that include DPI components. When no such DPI components exist in policies applicable to the network traffic, DPI is bypassed resulting in less use of the DPI processor in performing resource-intensive DPI. Thus, as may be appreciated, selective implementation of DPI may add significant efficiency in resource utilization.

To implement this selective DPI, a network device (e.g., hardware and/or software on a data path between two end points (e.g., a source end point and a destination end point)) may identify, based upon policies of the network device, a subset of the data received by the network device where DPI data will be used. For example, data packets received by the network device may include data packet characteristics, such as metadata (e.g., in the header of the data packet) that indicates source information (e.g., a source internet protocol (IP) address and/or source port number) associated with a source end point of the data packet, destination information (e.g., a destination IP address and/or destination port number) associated with a destination end point of the data packet, and/or a specific protocol used in transport of the data packet. Further, additional characteristics associated with the data packet may be obtained from other locations. For example, a role associated with a particular end point may be identified from a network device coupled to the particular end point. The network device may identify this role by querying an authentication server, for example, which tracks access to network by the particular end point.

Using the characteristics associated with the data packet(s), the network device may reduce a number of packets that are DPI'd, by, prior to submitting the received data packets for DPI, performing a DPI evaluation to filter out data packets from DPI where DPI of the data packets may not be used, as indicated by the network device's policies. Specifically, a pre-filtering data path lookup (e.g., “DPI-Eval policy lookup”) identifies a set of polices that apply to a received data packet. A policy is identified as applying to the received data packet when all criteria of the policy is met by the network device-known characteristics associated with the received data packet (i.e., the policy is “fully-qualified” by the network device-known characteristics associated with the received data packet) and/or when all criteria except DPI-identified criteria is met by the network device-known characteristics.

For the set of policies that apply to the received data packet, the network device identifies whether any of these policies include a DPI component, such as DPI-identified criteria and/or a DPI action. DPI-identified criteria may include criteria of the policy that is identified through DPI. For example, a policy's criteria may condition triggering of an action based upon a particular traffic type, which may be unknown to the network device, but is identifiable via DPI. Further, certain actions triggered by fully-qualified policies may rely on DPI and, thus, classified as a DPI action. For example, an Intrusion Detection System (IDS) inspection may be triggered when policy criteria is met. This IDS inspection may rely on data packet signatures and/or other information gleaned from DPI and, thus, the IDS inspection action may be classified as a DPI action.

When the network device identifies at least one policy that applies to the received data packet and includes a DPI component, the network device may selectively enable DPI for the received data packet, such as by providing a copy of the received data packet to a DPI processor that performs the DPI. When the network device identifies that there are not any polices that apply to the received data packet that include a DPI component, the network may bypass DPI for the received data packet, such as by refraining from providing a copy of the received data packet to the DPI processor.

In some cases, certain policies may be evaluated at a network device associated with the destination end point, as the network device associated with the destination end point (“destination network device”) may be the first network device to determine that a policy is fully qualified by the characteristics associated with the data packet. For example, in policies that include source and destination role criteria, the destination network device may receive the source role (e.g., via communication from a network device associated with the source end point (“source network device”)) and may know the destination role (e.g., which may be acquired from an authentication server). When the destination network device identifies that the source role and destination role meet the criteria of the policy and the policy includes a DPI component, the destination network device may program (e.g., set a DPI flag indicating to perform DPI in a lookup table of the destination network device) for a flow (e.g., source IP address to destination IP address) and reverse flow (e.g., destination IP address to source IP address) associated with the data packet, causing a DPI processor associated with the destination network device to selectively perform DPI for data packets indicating the flow and/or reverse flow. Further, a flag (e.g., a bit in a data packet header) may be set in a return packet to the source network device, indicating that the DPI processor associated with the destination network device is performing DPI. Based upon this flag, the source network device may bypass DPI, even after subsequently becoming aware of the source role and the destination role and that source role and destination role fully-qualify a policy with DPI components.

In this manner, DPI may be selectively enabled for received data packets where DPI may be used and/or selectively disabled/bypassed for received data packets where DPI may not be used. This may significantly improve computing resource (e.g., processor and/or memory resource) utilization, freeing up computing resources for other tasks.

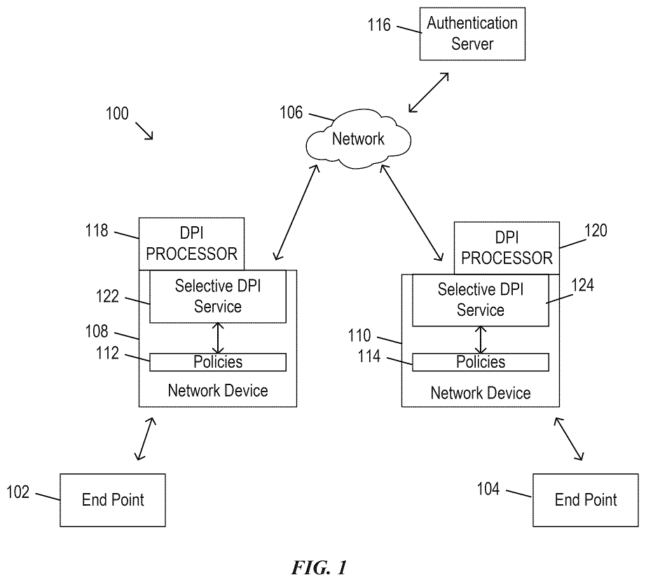

With this in mind, FIG. 1 is schematic diagram, illustrating a system 100 that implements efficient selective deep packet inspection (DPI), in accordance with aspects of the present disclosure. The system 100 includes end point 102 and end point 104 communicatively coupled via a network 106. The end points 102 and 104 may be any type of electronic device that communicates via the network 106. For example, the end points 102 and 104 may include a laptop, personal computer, server, or other electronic device. The end points 102 and 104 may provide data to one another via data packets transmitted through the network 106. For example, end point 102 may provide data packets to network device 108, which may forward the data packets via the network 106 to the end point 104. Similarly, end point 104 may provide data packets to network device 110, which may forward the data packets via the network 106 to the end point 102.

The network devices 108 and 110 may be any type of hardware and/or software device on a data path between end points 102 and 104. For example, the network devices 108 and 110 may be an intermediate data processing device (e.g., computer), network access device (e.g., an access point), and/or a data forwarding component (e.g., a network gateway, network router and/or network switch). The network devices 108 and 110 may include respective policies 112 and 114 that may indicate particular actions to implement when criteria associated with received data packets is met. For example, specified actions of policy 112 and/or policy 114 may include logging an indication of the received packet, dropping the received packet (e.g., in lieu of forwarding the received packet to its intended destination), and/or performing DPI on the received packet.

The criteria of the policy 112 and/or policy 114 may include, for example, criteria associated with a source of the received data packet, criteria associated with a destination of the received data packet, and/or criteria associated with the data packet itself. For example, with respect to source and/or destination criteria, the criteria may include a particular Internet Protocol (IP) address, a particular role, and/or other characteristic of the source and/or destination that is identifiable by the network devices 108 and/or 110. With respect to data packet criteria, the data packet criteria may include particular characteristics of the data packets, such as a particular application, particular ports, particular certificate and/or secure hash algorithm (SHA) exchanges, particular universal resource locators (URLs) and/or Server Name Identification (SNI) accesses, a particular version(s) of Transport Layer Security (TLS) and/or Secure Sockets Layer (SSL), and/or other particular characteristics identifiable by the network devices 108 and/or 110. When the network devices 108 and/or 110 identify that the criteria of the policy 112 and/or policy 114 is fully satisfied, the network devices 108 and/or 110 may identify that the policy 112 and/or policy 114 is fully-qualified and, thus, may trigger the specified actions of the policy 112 and/or policy 114.

The network devices 108 and 110 may identify the characteristics of the network traffic associated with criteria of the policies 112 and 114, respectively. To do this, in some cases, the network devices 108 and 110 may identify characteristics of received data packets by retrieving the characteristics from metadata associated with the data packet. For example, in some instances, the metadata, such as five-tuple information regarding the network communication (e.g., source IP address and/or destination IP address, source port and/or destination port, and/or communication protocol) may be accessed from a header of the received data packets.

In some instances, some characteristics may be identified by querying an authentication server 116. The authentication server 116, such as a Remote Authentication Dial-In User Service (Radius) server, may be tasked with centralized authentication, authorization, and accounting of communication on the network 106. As users of the end points 102 and 104 login via the authentication server 116, certain characteristics, such as the end point's role, may be identified and stored at the authentication server 116. The network devices 108 and 110 may query the authentication server 116 to receive characteristics for end points 102 and 104 that the network devices 108 and 110 are respectively coupled to. For example, network device 108 may query the authentication server 116 for characteristics associated with end point 102 and network device 110 may query the authentication server 116 for characteristics associated with the end point 104. Resulting respective end point criteria received from the authentication server 116 may be stored locally (e.g., in a local table and/or memory (not shown)) within the network devices 108 and/or 110, enabling policy implementation using this criteria.

The network devices 108 and/or 110 may each be associated with a respective DPI processor 118 and/or 120. Once the network devices 108 and/or 110 have acquired the relevant characteristics from the received data packets and/or the authentication server 116, these DPI processors 118 and/or 120 can begin processing the characteristics to determine to what extent, if any, to apply DPI and, if applied, whether to perform any implementation or remedial actions, as discussed in more detail below. The DPI processors 118 and/or 120 may be software implemented via a processor, such as a central processing unit (CPU) (not shown), of the corresponding network device 108 and/or 110. In some cases, the DPI processors 118 and/or 120 may include dedicated hardware (e.g., either local or remote to the corresponding network device 108 and/or 110). The DPI processors 118 and/or 120 may be used to enable the network devices 108 and/or 110 to identify additional characteristics of received data packets. For example, such characteristics may include a particular application, particular ports, certificate and/or secure hash algorithm (SHA) exchanges, universal resource locators (URLs) and/or Server Name Identification (SNI) accesses, and/or a particular version of Transport Layer Security (TLS) and/or Secure Sockets Layer (SSL) associated with the network traffic. These identified characteristics may be used, for example, to identify whether policy criteria is met and/or to identify a signature of network traffic for network intrusion detection and/or prevention.

As mentioned above, DPI may be a resource intensive process. Accordingly, the network devices 108 and/or 110 may include a respective Selective DPI Services 122 and/or 124, tasked with limiting network traffic (e.g., network packets) that are provided to the respective DPI processors 118 and/or 120 for DPI. As will be discussed in more detail below, the Selective DPI Services 122 and/or 124 may be tasked with identifying data packets associated with a policy (e.g., of respective policies 112 and/or 114) that includes a DPI component (e.g., DPI-identified criteria and/or DPI-based actions triggered based upon fully-satisfied triggering criteria). The Selective DPI Services 122 and/or 124 may submit data packets associated with such respective subset of policies to a respective one of the DPI processors 118 and/or 120 for implementation of the policy having the DPI component. However, when the received data packets are not associated with a policy that includes a DPI component, the Selective DPI Services 122 and/or 124 may bypass DPI for these packets, by refraining from providing such data packets to a corresponding one of the DPI processors 118 and/or 120. In this manner, the Selective DPI Services 122 and/or 124 may optimize resource utilization by bypassing DPI of unnecessary network traffic, resulting in freed-up resources that may be used for other functions (e.g., of the network devices 108 and/or 110), thus improving the functioning of the network devices 108, 110 and the overall system 100.

As used herein, “DPI-identified criteria” refers to criteria where DPI is used to identify whether the criteria is met. For example, if a user is running a TLS based service on a non-standard port and end points are connecting to that service, a Transmission Control Protocol (TCP) port 443 based policy may not help detect or block such traffic. Instead, a policy relying on DPI (e.g., a policy with DPI-identified criteria) may be used to detect and block such traffic. Likewise, if an administrator wants to migrate some services to use TLS version 1.2 and up from the current generation of software that supports SSL or TLS version 1.1, a policy including DPI-identified criteria can be used to identify all end points that are still using the older versions, triggering connection to those services and appropriately notification to patch the end points, such that there is seamless transition of the services to the newer TLS version.

Further, “DPI-based actions” refer to policy actions that include DPI. For example, such actions may include an action to perform DPI and/or Intrusion Detection System (IDS) inspection, which may rely on data packet signatures and/or other information gleaned from DPI.

The policies 112 and/or 114 may include role-based policies that include a source role criteria to a particular destination (e.g., destination IP address) and/or role-to-role (“group”) policies that include source and destination role criteria. Both role-based policies and role-to-role/group policies may include DPI components. Such policies may be referred to as Role and DPI based (RDB) policies and Group and DPI based (GDB) policies herein. As described in detail herein, the Selective DPI Services 122 and/or 124 may provide selective DPI for both RDB and GDB policies.

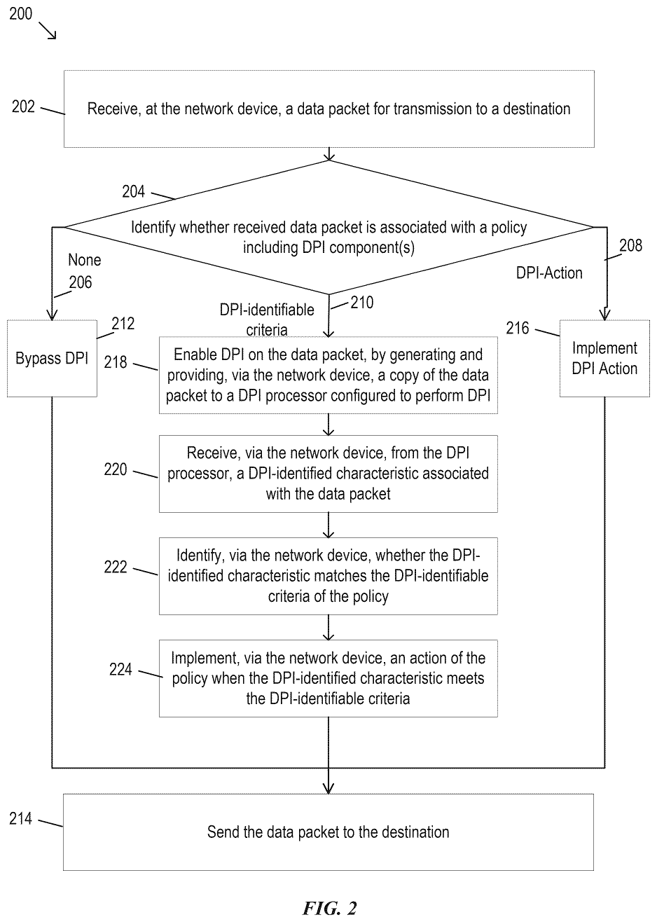

FIG. 2 is a flowchart, illustrating a process for selective DPI that may be performed, for example, by the system 100 described above, in accordance with aspects of the present disclosure. The process 200 includes receiving, at a network device (e.g., network device 108 and/or 110 of FIG. 1), a data packet for transmission to a destination (e.g., end point 104 of FIG. 1) (block 202). For example, the data packet may be received from an end point (e.g., end point 102 of FIG. 1) for transmission to another end point (e.g., end point 104 of FIG. 1).

At decision block 204, the process 200 includes identifying whether the received data packet is associated with a policy including DPI components, such as one or more DPI-identified criteria and/or one or more DPI actions. To do this, the policies (e.g., policies 112 and/or 114 of FIG. 1) may be accessed and a determination made as to whether any of the policies include DPI component(s). The data packet may be associated with policies that include a DPI-identifiable criteria, a DPI-action, and/or no DPI components. With respect to evaluation of a particular policy, when all criteria of a particular policy is met by criteria known by the network device (and, thus, no DPI-identified criteria is present) and no DPI-related action exists in the particular policy, the policy is identified as not including DPI components. If all policies associated with the received data packet do not include DPI components, the received data packet is identified as not associated with policies that include DPI components, as illustrated by arrow 206.

When the received data packet is not associated with any policies having a DPI component (arrow 206), DPI is bypassed for the received data packet (block 212). To do this, the network device refrains from sending a copy of the data packet to a DPI processor tasked with implementing the DPI. The network device may then satisfy the data packet transmission. At block 214, the process 200 may, thus, include sending the data packet to the destination (e.g., by forwarding the received data packet to an upstream network device).

In many cases, however, a policy associated with the received data packet will include a DPI component. For example, if a policy exists where the criteria is fully-met by known characteristics of the received data packet and the action to be triggered based upon the criteria being met is a DPI-related action, the policy is identified as being associated with a policy having a DPI-action, as illustrated by arrow 208. Further, if a policy exists where the policy's criteria is fully-met by known characteristics of the received data packet, except for at least one unknown characteristic that is identified via DPI, the data packet is identified as being associated with a policy having DPI-identified criteria, as illustrated by arrow 210. In this latter case, the DPI-identified criteria may be reviewed further to determine whether any action is warranted, as discussed below.

When, at decision block 204, the received data packet is associated with a policy that includes a DPI component, DPI may be performed to implement the policy. For instance, when the received data packet is associated with a fully-qualified policy (e.g., the data packet's known characteristics fully meet the criteria of the policy) having a DPI action (arrow 208), the DPI action may be implemented (block 216) without any further consideration. For example, when a policy's criteria are fully met by known characteristics of the received data packet, implementation of the DPI action (e.g., DPI performance, identification of a particular DPI-identified characteristic, or other action dependent on DPI) specified in the policy may be triggered.

Further, the data packet may be sent to the destination (block 214). The received data packet may be sent prior to and/or in parallel with implementation of the DPI.

When the received data packet is identified as associated with a policy that includes DPI-identified criteria (arrow 210), DPI may be performed to see if the DPI-identified criteria is met. Specifically, at block 218, DPI is enabled on the received data packet. DPI is enabled by generating and providing, via the network device (e.g., end network device 108 of FIG. 1), a copy of the received data packet to a DPI processor (e.g., DPI processor 118 of FIG. 1) tasked with performing the DPI.

In response to providing the copy of the received data packet (or a set of packet copies associated with the received data packet) to the DPI processor, the DPI processor may respond by providing a DPI-identified characteristic of the received data packet (or set of packet copies associated with the received data packet). Accordingly, the process 200 includes receiving, via the network device, from the DPI processor, the DPI-identified characteristic associated with the data packet (block 220).

The process 200 continues, by identifying, via the network device, whether the DPI-identified characteristic matches the DPI-identified criteria of the policy (block 222). For example, the DPI-identified characteristic may be compared to the DPI-identified criteria of the associated policy including the DPI-identified criteria to determine whether the DPI-identified criteria is met by the DPI-identified characteristic of the received data packet.

At block 224, the process 200 includes implementing, via the network device, an action of the associated policy including the DPI-identified characteristic when the DPI-identified characteristic meets the DPI-identified criteria. Conversely, when the DPI-identified characteristic does not meet the DPI-identified criteria, not all criteria of the policy is met and, thus, the process 200 may include refraining from implementing the action of the associated policy.

At block 214, the received data packet may be provided to the destination. As above, the received data packet may be sent prior to and/or in parallel with implementation of the DPI and/or during evaluation of whether the DPI-identified criteria is met.

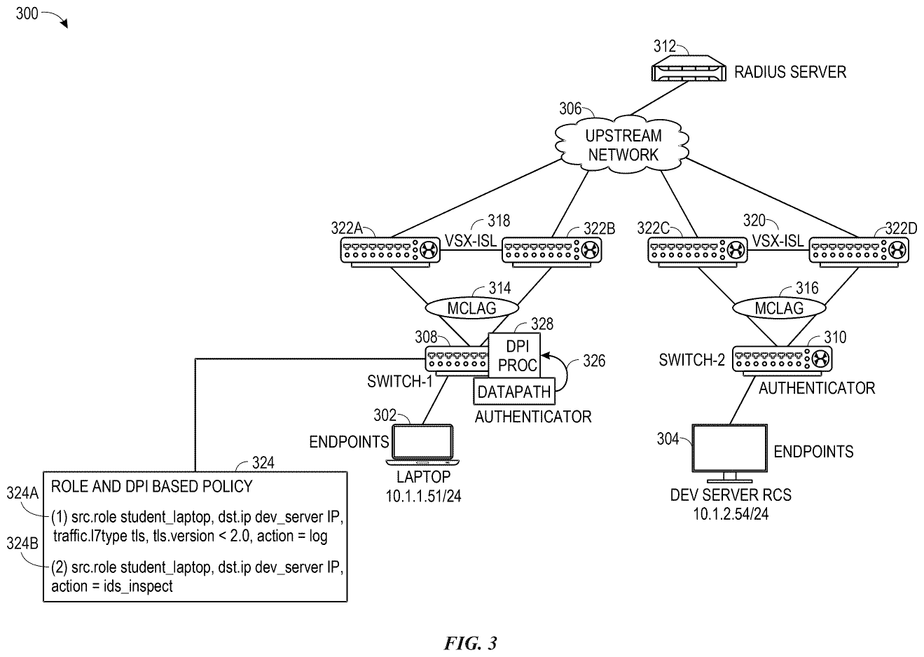

FIG. 3 is a schematic diagram, illustrating an example network infrastructure 300 that implements selective DPI, in accordance with aspects of the present disclosure. As with FIG. 1, the network infrastructure 300 includes an end point 302 (e.g., here, a laptop) and end point 304 (e.g., here, a server), which communicate over upstream network 306.

The network infrastructure 300 includes a network device 308 (e.g., here, a switch). The network device 308 may be tasked as an authentication component of the end point 302, as this network device 308 is connected to by the end point 302 to access the upstream network 306. Similarly, network device 310 (e.g., here, a switch) may act as an authenticator component for end point 304, which has connected to network device 310 to access the upstream network 306.

The authentication server (e.g., here a Radius Server 312) may provide centralized authentication, authorization, and accounting for access to the upstream network 306. Thus, the network devices 308 and 310 may communicate with the Radius Server 312 to obtain authorization for their respective end points 302 and 304 to communicate on the upstream network 306.

The network devices 308 and 310 may communicatively couple to the upstream network 306 via respective multi-chassis link aggregation groups (MCLAG(s)) 314 and 316 coupled to respective Virtual Switching Extension (VSX) Inter-Switch Link(s) (ISL(s)) 318 and 320. The MCLAGs 314 and 316 may provide communication ports across different chassis, for redundancy, in the event that one of the chassis fail. The VSX-ISL(s) 318 and 320 provide a layer 2 (e.g., Data Link Layer) interface between peer network switches 322A and 322B and peer network switches 322C and 322D, respectively.

As mentioned above, the network infrastructure 300 implements selective DPI, where received data packets associated with one or more policies including DPI components (e.g., DPI-identified criteria and/or DPI actions) are submitted for DPI, while received data packets not associated with one or more such policies are not submitted for DPI.

As illustrated, the network device 308 includes a local policy 324 to be implemented on received data packets. Both of the policies specified in the local policy 324 include DPI components and, thus, will be submitted for DPI. For example, the local policy 324 includes a first policy 324A that triggers an action logging an indication of the received data packet when: a source role (src. role) is “student_laptop”, a destination IP address (dst. ip) is an IP address represented by dev_server IP, and a layer 7 (e.g., application layer) traffic type (traffic. l7type) is “TLS”. Because the layer 7 traffic type is identified using DPI, this policy includes a DPI component (e.g., here, a DPI-identified criteria).

Further, the local policy 324 includes a second policy 324B that triggers an action to inspect the received data packet via an intrusion detection system (ids_inspect) when the source role is “student_laptop” and the destination IP address (dst. ip) is an IP address represented by dev_server IP. Because intrusion detection system inspection relies on DPI of the received data packet, this policy also includes a DPI component (e.g., here, a DPI action).

Because these policies both include DPI components, when data packets associated with these policies are received, these data packets will be submitted for DPI. However, when data packets received are not associated with one of the policies that include DPI components, these data packets will not be submitted for DPI, preserving resources for other tasks.

For example, a user may login to the end point 302, based upon authentication provided by the Radius server 312. The user login may indicate that the user that is logged in is a student and that the end point 302 is a laptop (e.g., identified based upon media access control (MAC) address of the end point 302 or other designation of end point 302). Accordingly, the Radius server 312 may establish a role of the end point 302 as “student_laptop”. An indication of the identified role of the end point 302 may be provided to the network device 308, which is the authenticator component for the end point 302. Thus, the network device 308 may identify the role of end point 302 for subsequent policy implementation.

The local policy 324 may be implemented when data packets are received at a data flow path 326 of the network device 308. A data packet may be provided from end point 302, specifying the destination of end point 304 (e.g., by providing the dev_server IP (e.g., 10.1.54) as destination IP address). The network device 308 may receive this data packet and identify associated policies of the local policy 324 that apply to the received data packet. Here, because the network device has identified that the end point 302 that sources the received data packet has a role of “student_laptop” and identifies that the destination IP address is the dev_server IP, the network device 308 identifies that all criteria for the first policy 324A is met except for the DPI-identified criteria. Thus, the network device 308 may identify the received data packet is associated with the first policy, which includes a DPI component. Accordingly, a copy of the received data packet may be selectively provided to the DPI processor 328 to initiate DPI.

Once enough packets associated with received data packet are DPI'd, the DPI processor 328 may provide one or more DPI-identified characteristics of the submitted data packets. One of these characteristics may include the layer 7 traffic type, which may be used to identify whether the DPI-identified criteria is met by the received data packet(s). If so, the action associated with the first policy 324A (e.g., a logging action) is performed. If not, the action associated with the first policy 324A is not performed.

The second policy 324B also triggers DPI for the received data packet. Indeed, all criteria of the second policy 324B are satisfied by characteristics known by the network device 308 without DPI (e.g., the “student_laptop” role identified based upon an indication from the Radius server 312 and the dev_server IP identified based upon metadata provided in a header of the received data packet). Thus, the second policy 324B is associated with the received data packet. Further, the second policy 324B includes the intrusion detection system inspection, which is a DPI action. Accordingly, the network device 308 may submit the received data packet to the DPI processor 328 for DPI.

Even though both first policy 324A and second policy 324B would trigger DPI for the received data packet, multiple DPIs of the received data packet are not performed. Instead, once DPI is kicked off once for a received data packet, the DPI results may be used for all policies that use DPI for the received data packet. Accordingly, a single DPI is performed for the received data packet and associated data packets (e.g., data packets of the same communication session) and used for each policy pertaining to the received data packet that include a DPI component.

Further, as mentioned herein, when a data packet is received and is not associated with a policy including a DPI component, the received data packet bypasses DPI. In one example, if the end point 302 provided a data packet destined for a different destination IP and/or a different user logged into the end point 302, resulting in a changed role of end point 302 to something other than “student_laptop”, no local policy 324 would be associated with the received data packet and, thus, DPI would be bypassed for this data packet. This may result in significant resource utilization efficiencies, as DPI may be quite resource-intensive.

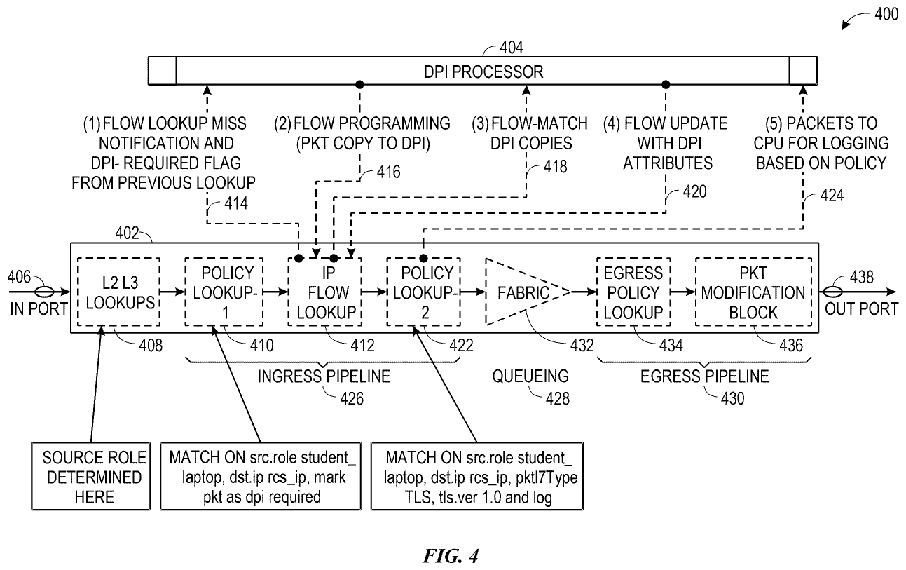

FIG. 4 is a schematic diagram, illustrating an example coordination 400 between a data flow path 402 and DPI processor 404 to implement the first policy 324A of FIG. 3 via selective DPI, in accordance with aspects of the present disclosure. As illustrated, the data flow path 402 includes an in port 406 where data packets may be received from an end point (e.g., end point 302 of FIG. 3). One or more Layer 2 and/or Layer 3 lookups (L2 L3 lookups) 408 (e.g., lookup table queries) may be performed to identify whether policy criteria are met by a received data packet. For example, to implement the first policy 324A of FIG. 3, the source role, destination IP and Layer 7 traffic type need to be identified. Here, the source role may be identified from the L2 L3 lookups 408. Thus, the L2 L3 lookups 408 may identify the source role as “student_laptop”.

The data flow path 402 also includes a policy evaluation for policies applicable to the data packet that include DPI components (DPI-Eval policy lookup 410). As mentioned above, the first policy 324A includes criteria for a Layer 7 traffic type, which is identified from DPI. The DPI-Eval policy lookup 410 identifies that the “student_laptop” source role identified in the L2 L3 lookups 408 meets the criteria of the source role criteria and also identifies that a destination IP address provided as metadata for the received data packet (e.g., in the data packet header) meets the destination IP address criteria of the first policy. Based upon this fully qualified criteria (other than the DPI-identified criteria) the DPI-Eval policy lookup 410 may identify that the received data packet is associated with a policy including a DPI component and may trigger DPI for the received data packet. Had the characteristics of the received data packet not provided full qualification of the policy's criteria (other than the DPI-identified criteria), DPI would not be triggered by this policy for the received data packet.

To trigger DPI for the received data packet, a flag (DPI required flag) associated with the received data packet, indicating that DPI is required may be set. At the IP flow lookup 412, a determination is made as to whether to provide a copy of the received data packet for DPI. Specifically, the IP flow lookup 412 identifies whether there is a flow lookup miss (e.g., no registration of DPI packets associated with the current data packet) and the DPI required flag. Because the DPI required flag is set based upon the DPI-Eval Policy lookup 410, a copy of the received data packet is provided to the DPI processor 404 (arrow 414). Additionally, an indication of the ongoing DPI may be provided back to the IP flow lookup 412, enabling flow-matches of subsequent received packets associated with the same communication session, such that these subsequently received data packets may be aggregated with the DPI of the received data packet (arrow 416). The subsequently received data packets associated with the received data packet (e.g., packets matching a common communication session) are flow-match upon subsequent IP flow lookups 412 and are, thus, also provided to the DPI processor 404 (arrow 418), enabling DPI of the aggregated received data packets (flow-matched DPI data packet copies). Eventually, DPI of enough of these data packets will result in identifying the DPI-identified characteristics of the received data packets, which may be returned to the IP flow lookup 412 (arrow 420). For example, the Layer 7 traffic type may be identified via DPI and returned to the IP flow lookup 412.

Once the DPI-identified characteristics are returned, a second policy lookup 422 may be performed to identify whether the remaining DPI-identified criteria of the first policy 324A is met. For example, first policy 324A conditions the logging action on the Layer 7 traffic type being TLS with a version<2.0. In the current example of FIG. 4, the DPI processor 404 may identify that TLS Version 1.0 is being used and thus, the second policy lookup 422 may identify that the remaining criteria of first policy 324A is met. Thus, logging of the received data packets may be triggered by providing the received data packets identified as satisfying the first policy 324A criteria to a processor (e.g., a CPU implementing the DPI processor) for logging (arrow 424).

The L2 L3 lookups 408, DPI-Eval policy lookup 410, IP flow lookup 412, and Second policy lookup 422 may be collectively referred to as an ingress pipeline 426. While certain functions of the ingress pipeline 426 are working towards completion, the queueing 428 and egress pipeline 430 functions may be performed in parallel. For example, as mentioned above, numerous received packets may be DPI'd before the DPI-identified characteristics are identified and policy may be implemented. Accordingly, while data packet copies are provided to the DPI processor 404 for DPI, the received data packets may be provided for queueing 428 (e.g., to the fabric 432). Further, these packets may be provided through an egress pipeline 430, undergoing egress policy lookup 434 to implement any egress policies associated with the received data packets and an egress data packet modification block 436 to modify the data packets, as desired for output to upstream network devices via the out port 438.

Role-to-role policies may be simpler to author, less error prone and easy to manage and update over time than role-based policies that do not include a destination role, but instead a more-static destination criteria (e.g., destination IP address). However, such role-to-role policies (e.g., including role criteria for both a source and destination) may be somewhat more complex to handle when compared with role-based policies that do not include a destination role criteria. This is because network devices that implement the policies are typically aware of roles associated with the source end point, but unaware of destination roles and, thus, it is a more complex process to fully qualify the criteria of role-to-role policies.

The network that supports these role-to-role policies carries the source role (source. role) as part of the data packet flowing from the source end point to the destination end point. The source role is typically provided via an encoding of the source role as part of the group policy option (GPO) tag of the data packet's header (e.g., a virtual extensible (Vx) local area network (LAN) (VxLAN) header). Client connectivity is facilitated via a network overlay, stitched together by a network fabric or underlay. Once the network traffic reaches the egress switch (e.g., coupled to the destination end point), the destination role of that end point is determined by the egress network device (e.g., switch) and then the above policy can be enforced using the destination role identified by the egress network device and the source role identified from the GPO tag in the data packet header. Accordingly, role-to-role policies may be implemented/enforced on the egress network device in lieu of the source network device, as the egress network device is able to fully qualify both the source and destination role criteria. However, when a return data packet is provided from the destination end point to the source end point via the egress network device, the egress network device will not be able to qualify the role of the destination of the return data packet (i.e., the role of the source network device) and thus, be unable to fully qualify the criteria of the role-to-role policy. Accordingly, additional processing may be performed to support role-to-role policies.

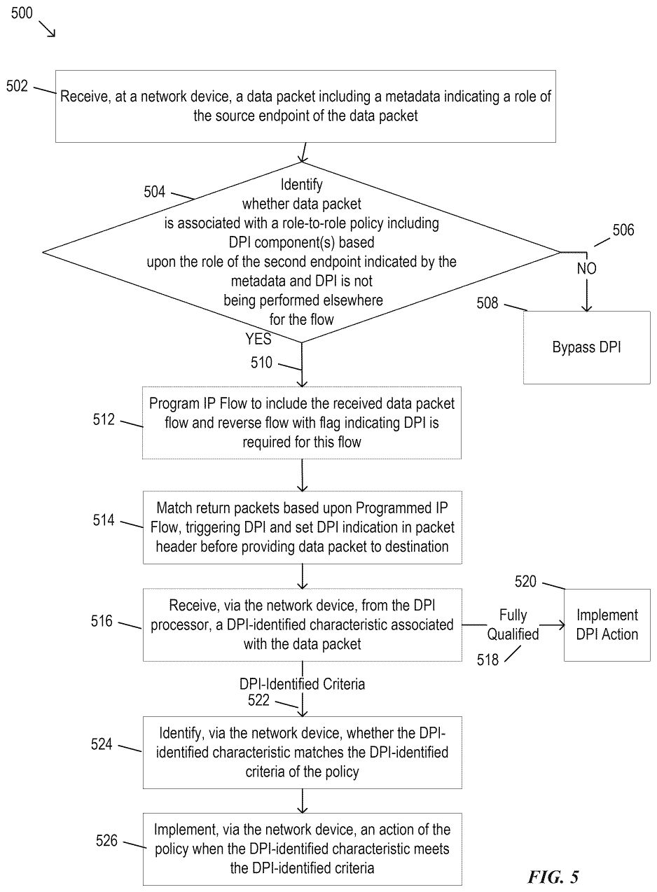

FIG. 5 is a flowchart, illustrating a process 500 for implementing role-to-role policies with DPI, in accordance with aspects of the present disclosure. The process 500 includes receiving at a network device, a data packet including a metadata indicating a role of the source end point of data packet (block 502). For example, the metadata may be included in a header of the received data packet, for example in a GPO tag.

At decision block 504, the process 500 includes identifying whether a role-to-role policy is associated with a policy including DPI component(s) (e.g., DPI-identified criteria and/or action) based upon the role of the second end point indicated by the metadata. For example, role-to-role policies may be evaluated to identify whether the destination role of the destination end point connected to the network device and, thus, known by the network device, satisfy criteria of a role-to-role policy. If so, then the data packet is associated with a DPI component. If not, then the data packet is not associated with a DPI component.

The decision block 504 also includes identifying whether DPI is being performed elsewhere for the flow. This may be identified based upon an indication provided in a header of the data packet, which is set when DPI is performed for the data packet. In this manner, when a data packet is received, selective DPI may be determined based upon whether DPI is already occurring elsewhere and, thus, is not to be performed at the current network device.

If the data packet is not associated with a role-to-role policy that includes DPI component(s) and/or DPI is being performed for the flow elsewhere (arrow 506), DPI may be bypassed (block 508), by refraining from providing a copy of the data packet to the DPI processor. However, when the data packet is associated with role-to-role policy with a DPI component and DPI is not being performed elsewhere (arrow 510), additional processing may be performed to ensure that DPI is performed to facilitate implementation of the role-to-role process. At block 512, the IP flow lookup table is programmed to include the flow of the received data packet and the corresponding reverse (e.g, symmetric) flow with a flag indicating DPI is required for this flow. Thus, even when there is no role-to-role policy match because destination roles are unknown by the network device, DPI will be triggered based upon the programming in the IP flow lookup table.

Accordingly, at block 514, upon return data packets being received from the destination end point for transmission back to the source end point, DPI is triggered based upon a match of the flow of the return data packets in the programmed IP flow lookup table. Thus, a copy of the return data packet may be provided to the DPI processor for DPI. Further, an indication of the DPI performance may be provided in one or more bits of the data packet header. Accordingly, when the data packet is provided to the destination network device, the indication in header that DPI is being performed elsewhere will result in bypassing DPI for the flow of the received data packet and/or subsequent return data packets.

At block 516, DPI-identified characteristics associated with the data packet are received from the DPI processor. For example, as mentioned above, a TLS version associated with the data packet may be identified, enabling implementation of the DPI action and/or qualification of DPI-identified criteria of the role-to-role policy.

When no DPI-identified criteria is in the role-to-role policy (i.e., is fully qualified), but the fully qualified role-to-role policy includes a DPI action (e.g., an action dependent on DPI, such as an Intrusion Detection System inspection action) (arrow 518), the DPI action may be implemented based upon the received DPI-identified characteristic(s) (block 520).

When the role-to-role policy does include DPI-identified criteria (arrow 522), the process 500 includes identifying, via the network device, whether the DPI-identified characteristic matches the DPI-identified criteria of the policy (block 524). For example, when the role-to-role policy includes a criteria that a TLS version is less than 2.0, the TLS version identified via DPI may be compared to this criteria to determine whether the role-to-role policy's DPI-identified criteria is met by the DPI-identified characteristic of the data packet(s).

When the DPI-identified characteristic meets the DPI-identified criteria, the role-to-role policy becomes fully qualified. Thus, the action associated with the role-to-role policy may be implemented (block 526).

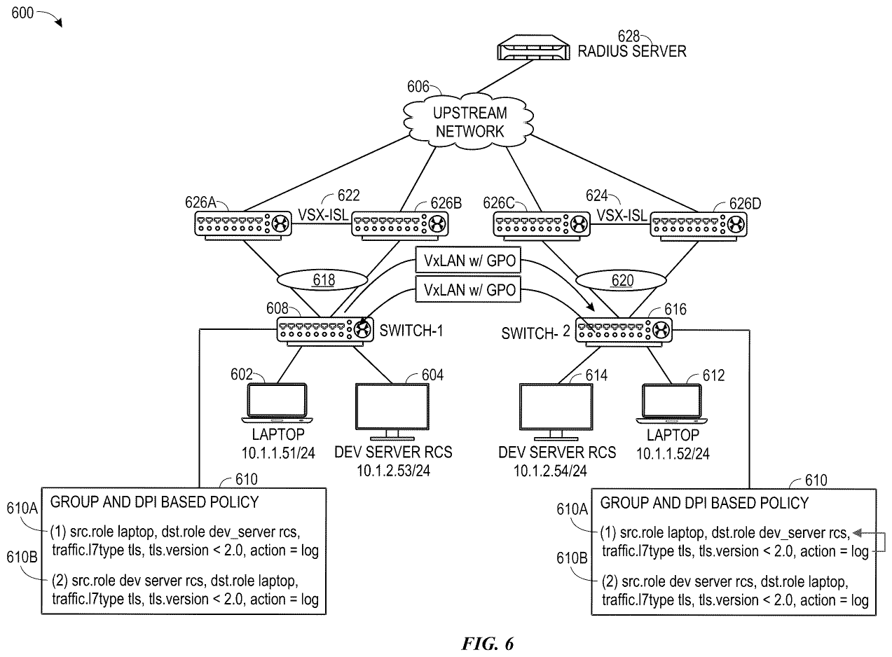

FIG. 6 is a schematic diagram, illustrating an example network infrastructure 600 that implements a role-to-role policy with selective DPI, in accordance with aspects of the present disclosure. As illustrated, the network infrastructure 600 includes a laptop end point 602 and a Development (Dev) Server providing rich communication services (RCS) (Dev Server RCS 604) accessing an upstream network 606 via a switch 608. The switch 608 includes role-to-role policies 610A and 610B (collectively role-to-role policies 610).

Additionally, the network infrastructure 600 includes a laptop end point 612 and a dev server RCS end point 614 accessing the upstream network 606 via a switch 616 with the same policy 610 of switch 608. As with the network infrastructure 300 of FIG. 3, the network infrastructure 600 may communicatively couple the switch 608 and the switch 616 to the upstream network 606 via respective multi-chassis link aggregation groups (MCLAG(s)) 618 and 620 coupled to respective Virtual Switching Extension (VSX) Inter-Switch Link(s) (ISL(s)) 622 and 624. The MCLAGs 618 and 620 may provide communication ports across different chassis, for redundancy, in the event that one of the chassis fails. The VSX-ISL(s) 622 and 624 provide a layer 2 (e.g., Data Link Layer) interface between peer network switches 626A and 626B and peer network switches 626C and 626D, respectively.

When the laptop end point 602 initiates a new connection to the dev server RCS end point 614, providing a data packet to switch 608, switch 608 will not have any policy with DPI components match. When selective DPI is enabled and there is no match with policies having DPI components (e.g., in a DPI-eval policy table lookup), a miss with respect to the IP flow lookup will be ignored/suppressed. Therefore, switch 608 will not trigger DPI on the received data packet.

The data packet will be encoded with the source role (i.e., laptop) in the data packet header and will be transported over the VSX-ISL 622 tunnel to switch 616 where the dev server RCS end point 614 is located. Switch 616 identifies the source role from the data packet header and knows the role of the destination end point (i.e., Dev server RCS end point 614) (e.g., based upon role information provided by an authentication server, such as Radius Server 628) and thus identifies a match with a policy having DPI components (e.g., in a DPI-eval policy table). The switch 616 may, thus, program the flow into the IP flow lookup table with a flag that indicates that DPI is required for this traffic.

Switch 616 may also program the return path (the reverse flow) into the same IP flow lookup table with a flag that similarly indicates that DPI is required for the return flow. The switch 616 may perform this programming upfront, even before an actual return packet is received by switch 616. This return flow programming ensures that DPI will be performed on the return packet, which would otherwise not match any DPI-eval policy for lack of knowledge about the destination role (i.e., of laptop end point 602) on Switch2.

When the dev server RCS end point 614 sends the return traffic, it will not match any DPI-eval policy in a DPI-eval policy table lookup, as mentioned above. However, the return data packet will match the IP flow lookup table entry that was programmed upfront. This match will indicate that DPI is required for this flow and therefore the return data packet is sent to the DPI processor for DPI.

Through DPI of data packets of the flows, the DPI processor may glean data packet characteristics, such as TLS exchange information and update the IP flow lookup table with the appropriate attributes associated with the flow (e.g., Layer 7 Type=TLS, TLS. version=1.0). As traffic passes through the data path, the post-IP flow lookup table policy will have a match on the TLS version criteria of policy 610A, fully qualifying the policy 610A, which triggers the logging action of the policy 610A.

Likewise, for policies with a DPI-dependent action, such as IDS inspection, the IP flow lookup table is programmed with both the fully-role-qualified forward and reverse flows, flagged to send data packets to the DPI processor for IDS inspection. An IDS of the DPI processor can, thus, identify signature patterns with respect to data packets of the flow and raise an alert if it detects a vulnerable signature pattern that needs further investigation or remediation. The IDS may also program a label to the IP flow lookup table to indicate that a flow is malicious and if there is a policy to match on this label with a drop action, the data packets of the flow will be dropped.

As may be appreciated, when implementing selective DPI, DPI for role-to-role policies may typically be handled by the destination network device that the destination end point accesses the upstream network 606 from. Accordingly, when the laptop end point 602 sources communication with Dev server RCS end point 614 or Dev server RCS end point 604 sources communication with Laptop end point 612, DPI may be implemented at the switch 616. However, when Dev server RCS end point 614 sources communication with laptop end point 602 or laptop end point 612 sources communication with Dev server RCS 604, DPI may be performed by switch 608.

When the end points access the upstream network 606 from the same authorization network device, that network device is aware of the roles of both the source and destination end points and, thus, may perform the DPI. For example, if laptop end point 602 sources communication with Dev server RCS 604 or vis versa, the switch 608 may perform the DPI. If laptop end point 612 sources communication with dev server RCS end point 614 or vis versa, the switch 616 may perform the DPI.

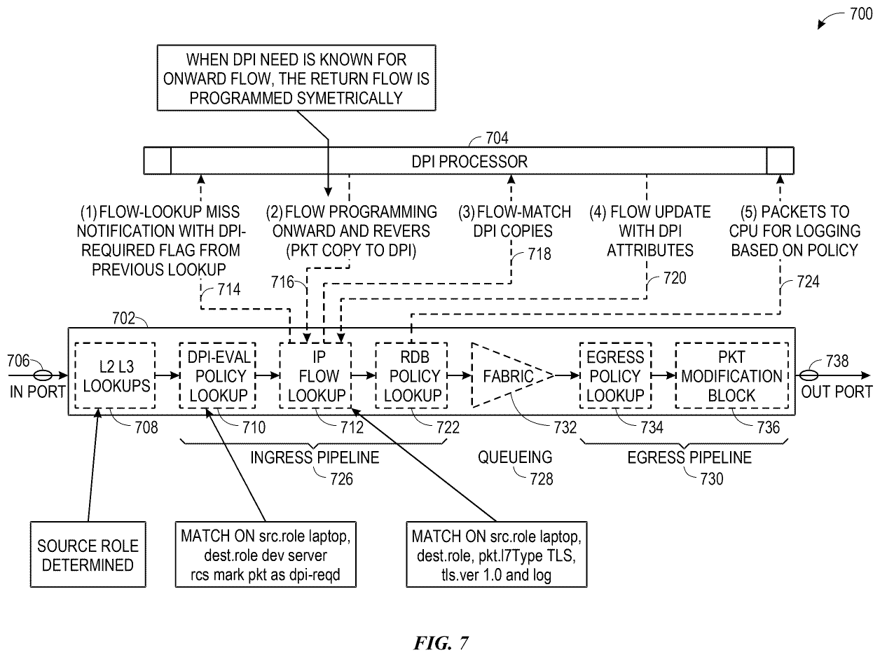

FIG. 7 is a schematic diagram, illustrating an example coordination 700 between a data flow path 702 and DPI processor 704 to implement the role-to-role policy with DPI of FIG. 6, in accordance with aspects of the present disclosure. As illustrated, the data flow path 702 includes an in port 706 where data packets may be received from an end point. One or more Layer2 and/or Layer 3 lookups (L2 L3 lookups) 708 (e.g., lookup table queries) may be performed to identify whether policy criteria are met by a received data packet. For example, to implement the policy 610 of FIG. 6, the source role, destination IP and Layer 7 traffic type need to be identified. Here, the source role (e.g., “laptop”) may be identified from packet header information encoded from a source network device. The destination role may be identified from the L2 L3 lookups 708, as it is being performed from an authenticator network device of the destination end point. Thus, the L2 L3 lookups 708 may identify the destination end point role as “Dev Server RCS”.

The data flow path 702 also includes a DPI-Eval policy lookup 710. This lookup identifies whether the received data packet is associated with any policies that include DPI components. As mentioned above, the policy 610 includes criteria for a Layer 7 traffic type, which is identified from DPI. The DPI-Eval policy lookup 710 identifies, based upon the identified source and destination roles, whether any policies including DPI are fully qualified (other than the DPI-identified criteria) based upon the identified source and destination roles meeting criteria of the policy. Based upon this fully qualified criteria (other than the DPI-identified criteria) the DPI-Eval policy lookup 710 may identify that the received data packet is associated with a policy including a DPI component and may trigger DPI for the received data packet. Had the characteristics of the received data packet not provided full qualification of the policy's criteria (other than the DPI-identified criteria), DPI would not be triggered by this policy for the received data packet.

To trigger DPI for the received data packet, a flag (DPI required flag) associated with the received data packet, indicating that DPI is required may be set. At the Internet Protocol (IP) flow lookup 712, a determination is made as to whether to provide a copy of the received data packet for DPI. Specifically, the IP flow lookup 712 identifies whether there is a flow lookup miss (e.g., no registration of DPI packets associated with the current data packet), the DPI required flag, and an indication of whether DPI is already being performed elsewhere (e.g., via a DPI performance flag in the data packet header). When the DPI required flag is set based upon the DPI-Eval Policy lookup 710 and there is no indication of DPI being performed elsewhere, a copy of the received data packet is provided to the DPI processor 704 (arrow 714). Additionally, an indication of the ongoing DPI may be provided back to the IP flow lookup 712, enabling flow-matches of subsequent received packets associated with the same communication session, such that these subsequently received data packets may be aggregated with the DPI of the received data packet (arrow 716). The subsequently received data packets associated with the received data packet (e.g., packets matching a common communication session) are flow-match upon subsequent IP flow lookups 712 and are, thus, also provided to the DPI processor 704 (arrow 718), enabling DPI of the aggregated received data packets (flow-matched DPI data packet copies). Eventually, DPI of enough of these data packets will result in identifying the DPI-identified characteristics of the received data packets, which may be returned to the IP flow lookup 712 (arrow 720). For example, the Layer 7 traffic type may be identified via DPI and returned to the IP flow lookup 712.

Once the DPI-identified characteristics are returned, a second policy lookup 722 may be performed to identify whether the remaining DPI-identified criteria of the policy 610 is met. For example, policy 610 conditions the logging action on the Layer 7 traffic type being TLS with a version<2.0. In the current example of FIG. 7, the DPI processor 704 may identify that TLS Version 1.0 is being used and thus, the second policy lookup 422 may identify that the remaining criteria of policy 610 is met. Thus, logging of the received data packets may be triggered by providing the received data packets identified as satisfying the policy 610 criteria to a processor (e.g., a CPU implementing the DPI processor) for logging (arrow 724).

The L2 L3 lookups 708, DPI-Eval policy lookup 710, IP flow lookup 712, and Second policy lookup 722 may be collectively referred to as an ingress pipeline 726. While certain functions of the ingress pipeline 726 are working towards completion, the queueing 728 and egress pipeline 730 functions may be performed in parallel. For example, as mentioned above, numerous received packets may be DPI'd before the DPI-identified characteristics are identified and policy may be implemented. Accordingly, while data packet copies are provided to the DPI processor 704 for DPI, the received data packets may be provided for queueing 728 (e.g., to the fabric 732). Further, these packets may be provided through an egress pipeline 730, undergoing egress policy lookup 734 to implement any egress policies associated with the received data packets and an egress data packet modification block 736 to modify the data packets, as desired for output to upstream network devices via the out port 738.

As may be appreciated, the current techniques provide significant value. For example, rather than implementing DPI for all data packets flowing through a network device when the network device includes policies that use DPI, the current techniques provide a more efficient solution, limiting DPI to data packets that are associated with/fully qualify a policy that uses such DPI. In this manner, un-necessary DPI is avoided, enabling a more efficient use of memory and processing resources, which can be allocated other functions of the network device.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A network device, configured to:
receive, at the network device, a data packet for transmission to a destination;
identify, via the network device, that the data packet is associated with a policy comprising data packet inspection (DPI)-identified criteria;
in response to identifying that the data packet is associated with the policy comprising the DPI-identified criteria:
selectively enable DPI on the data packet, by providing, via the network device, a copy of the data packet to a DPI processor configured to perform DPI;
receive, via the network device, from the DPI processor, a DPI-identified characteristic associated with the data packet;
identify, via the network device, whether the DPI-identified characteristic matches the DPI-identified criteria of the policy; and
implement, via the network device, an action of the policy when the DPI-identified characteristic matches the DPI-identified criteria; and
send the data packet to the destination.

2. The network device of claim 1, configured to:
receive, at the network device, a second data packet;
identify, via the network device, that the second data packet is not associated with any policy comprising any DPI-identified criteria; and
in response to identifying that the second data packet is not associated with any policy comprising any DPI-identified criteria, bypass DPI on the second data packet by refraining from generating and providing a copy of the second data packet to the DPI processor.

3. The network device of claim 1, configured to: in response to identifying that the data packet is associated with the policy comprising the DPI-identified criteria:
setting a flag, indicating that the DPI on the data packet is to be performed, in metadata associated with the data packet; and
in response to the flag being set in the metadata, generating and providing the copy of the data packet to the DPI processor.

4. The network device of claim 3, configured to:
in response to the flag being set:
perform an Internet Protocol (IP) flow lookup to identify whether the data packet is associated with existing packets under DPI; and
when the data packet is associated with a set of existing packets under DPI, aggregate DPI of the data packet with DPI of the set of existing packets under DPI to receive the DPI-identified characteristic of the data packet.

5. The network device of claim 1, comprising the DPI processor, wherein the network device is configured to:
perform, via the DPI processor, the DPI on the data packet.

6. The network device of claim 1, configured to:
identify whether the data packet is associated with a policy that includes DPI-identified criteria, by:
performing at least one of a Layer 2 (L2) lookup or a Layer 3 (L3) lookup on the data packet to identify a first characteristic of the data packet; and
identifying whether any policies having criteria matching the first characteristic of the data packet include the DPI-identified criteria.

7. The network device of claim 6, wherein the first characteristic of the data packet comprises a role associated with a source of the data packet.

8. The network device of claim 6, configured to:
provide, via the network device, to a second network device coupled to the destination, via a virtual extensible local area network (VxLAN) tunnel, metadata associated with the data packet, the metadata indicating the first characteristic of the data packet, enabling the second network device to evaluate whether policy criteria of the second network device is met using the first characteristic of the data packet.

9. The network device of claim 1, configured to:
in response to identifying that the data packet is associated with the policy comprising the DPI-identified criteria, cause return flow DPI, by generating, via the network device, a symmetric policy to the policy.

10. The network device of claim 1, configured to:
receive, at the network device, a second data packet from a second source different than the network device, the second data packet comprising metadata indicating a role of the second source;
identify, via the network device, whether a source role criteria of a role-to-role policy is met based upon the role of the second source indicated by the metadata;
identify, via the network device, whether a destination role criteria of the role-to-role policy is met based upon a role of a destination of the second data packet known by the network device;
identify whether the role-to-role policy is fully-qualified based upon the source role criteria of the role-to-role policy and the destination role criteria of the role-to-role policy being met; and
in response to identifying that the role-to-role policy is fully-qualified, implement an action specified by the role-to-role policy.

11. The network device of claim 10, configured to:
identify that the role-to-role policy is fully-qualified except that the role-to-role policy includes an additional criteria identifiable through DPI; and
in response to identifying that the role-to-role policy is fully-qualified except that the role-to-role policy includes the additional criteria identifiable through DPI, program an IP flow lookup table to cause DPI for a forward flow associated with the second data packet and a reverse flow associated with the second data packet.

12. The network device of claim 10, configured to:
identify that the action specified by the role-to-role policy comprises a DPI-dependent action; and
in response to identifying that the action specified by the role-to-role policy comprises a DPI-dependent action, trigger DPI on the second data packet.

13. The network device of claim 10, configured to:
identify, based upon data in a header of the second data packet, whether DPI for the second data packet is being performed elsewhere; and
selectively triggering DPI when identifying that DPI is not being performed elsewhere.

14. The network device of claim 1, wherein the action of the policy comprises at least one of: logging an indication of the data packet or performing an intrusion detection system (IDS) inspection.

15. A network device-implemented method, comprising:
receiving, at a network device, a data packet;
identifying, via the network device, that deep packet inspection (DPI) conditions are met by the data packet, the DPI conditions comprising:
the data packet being associated with a role-to-role policy providing a source role criteria and a destination role criteria;
the role-to-role policy comprising a DPI component; and
DPI of the data packet not being performed elsewhere;
in response to identifying that the DPI conditions are met, selectively triggering DPI of the data packet; and
sending, via the network device, the data packet to a destination of the data packet.

16. The network device-implemented method of claim 15, comprising identifying that the data packet is associated with the role-to-role policy by:
identifying a source role associated with a source of the data packet from a header of the data packet;
identifying a destination role associated with the destination of the data packet; and
determining that the source role criteria is met by the source role and the destination role criteria is met by the destination role.

17. The network device-implemented method of claim 15, comprising:
triggering the DPI of the data packet by programming an internet protocol (IP) flow table with a DPI indication associated with a forward flow and reverse flow of the data packet; and
encoding a header of the data packet with an indication that DPI is being performed.

18. A system, comprising:
a deep packet inspection (DPI) processor configured to perform DPI on received data packets;
a network device, configured to:
receive a data packet for transmission to a destination;
identify that the data packet is associated with a policy comprising DPI-identified criteria;
in response to identifying that the data packet is associated with the policy comprising the DPI-identified criteria, selectively enable DPI on the data packet, by providing, via the network device, a copy of the data packet to the DPI processor; and
transmit the data packet to the destination.

19. The system of claim 18, wherein the network device is configured to:
in response to the DPI being selectively enabled on the data packet, encode, in a header of the data packet, an indication that the DPI is being performed by the DPI processor.

20. The system of claim 19, wherein the network device is configured to transmit a return data packet associated with the data packet to a source of the data packet, wherein the return data packet comprises the indication that the DPI is being performed by the DPI processor.
